(19) United States
(12) Patent Application Publication
(10) Pub. No.: US 2006/0200054 A1
(43) Pub. Date: Sep. 7, 2006

(54) Supplemental support structures adapted to receive a non-invasive dynamic motion therapy device

(76) Inventors: Roger J. Talish, Hillsborough, NJ (US); Kenneth Urgovitch, Montague, NJ (US); Donald E. Krompasick, Bethlehem, PA (US)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/369,611

(22) Filed: Mar. 6, 2006

Related U.S. Application Data
(60) Provisional application No. 60/659,159, filed on Mar. 7, 2005.

(51) Int. Cl. A61H 1/00

(52) U.S. Cl. 601/98; 601/90; 601/24

(57) ABSTRACT

Several embodiments of supplemental support structures for receiving a non-invasive dynamic motion therapy device are provided. The non-invasive dynamic motion therapy device provides vibrational treatment to patients suffering from postural instability and other conditions, such as cystic fibrosis, as well as paraplegic patients. The non-invasive dynamic motion therapy device is typically employed following a determination that vibrational treatment of a patient's musculoskeletal system and/or internal organs would produce a beneficial result. The supplemental support structures enable the patient to be supported on a vibrational table or unstable vibrating platform of the non-invasive dynamic motion therapy device during treatment.

### PRIORITY

This application claims priority to a United States provisional patent application filed on Mar. 7, 2005 and assigned U.S. Provisional Patent Application Ser. No. 60/659,159; the entire contents of which are incorporated herein by reference.

### BACKGROUND OF THE INVENTION

1. Technical Field

This disclosure relates to a medical treatment apparatus. More particularly, the disclosure relates to supplemental support structures adapted to receive a non-invasive dynamic motion therapy device. The non-invasive dynamic motion therapy device provides vibrational treatment to patients suffering from postural instability and other conditions, such as cystic fibrosis, as well as paraplegic patients.

2. Description of the Related Art

A method of using resonant vibrations for treating postural instability is described in U.S. Pat. No. 6,607,497 B2. The method includes the steps of (a) providing a non-invasive dynamic motion therapy device having a vibration table with a non-rigidly supported platform; (b) permitting the patient to rest on the non-rigidly supported platform for a predetermined period of time; and (c) repeating the steps (a) and (b) over a predetermined treatment duration. Step (b) includes the steps of (b1) measuring a vibrational response of the patient's musculoskeletal system using a vibration measurement device; (b2) performing a frequency decomposition of the vibrational response to quantify the vibrational response into specific vibrational spectra; and (b3) analyzing the vibrational spectra to evaluate at least postural stability.

The method described in U.S. Pat. No. 6,607,497 B2 entails the patient standing on the vibration table or unstable vibrating platform. The patient is then exposed to a vibrational stimulus by the unstable vibrating platform. The unstable vibrating platform causes a vibrational perturbation of the patient's neuro-sensory control system. The vibrational perturbation causes signals to be generated within at least one of the patient's muscles to create a measurable response from the musculoskeletal system. These steps are repeated over a predetermined treatment duration for approximately ten minutes a day in an effort to improve the postural stability of the patient.

Often it is necessary to provide support to the patient being treated by the dynamic motion therapy device to aid the patient in comfortably and non-painfully resting on the non-rigidly supported platform during treatment. Accordingly, there is a need for supplemental support structures adapted to receive the non-invasive dynamic motion therapy device for providing support to a paraplegic patient or a patient being treated for postural instability or other condition, such as cystic fibrosis, and kidney and gall stones, as described in U.S. patent application Ser. No. 11/207,335, filed on Aug. 18, 2005, using resonant vibrations or a vibrational stimulus produced by the non-invasive dynamic motion therapy device as described in U.S. Pat. No. 6,607,497 B2, the contents of the provisional patent application and the patent are incorporated herein by reference.

### SUMMARY OF THE INVENTION

The present disclosure describes several embodiments of a supplemental support structures adapted to receive a non-invasive dynamic motion therapy device. The non-invasive dynamic motion therapy device includes a vibration table having a non-rigidly supported platform for providing vibrational treatment to patients suffering from postural instability and other conditions, such as cystic fibrosis, as well as paraplegic patients. The non-invasive dynamic motion therapy device further includes at one end of the vibration table a display unit having a display for displaying informational and non-informational contents, such as treatment-related data.

The non-invasive dynamic motion therapy device is typically employed following a determination that vibrational treatment of a patient's musculoskeletal system and/or internal organs would produce a beneficial result. The supplemental support structures in accordance with the present disclosure enable the patient to be supported on the non-rigidly supported platform of the non-invasive dynamic motion therapy device during treatment.

In one embodiment of the present disclosure, the supplemental support structure is a kneeling chair support structure which includes a kneeling chair having a seat, kneeling pads and a frame supporting the seat and kneeling pads. The support structure further includes a rectangular base having a central recess or opening configured and dimensioned for receiving the non-invasive dynamic motion therapy device. The rectangular base further includes mounting shoes for connecting to the frame and thereby, positioning the frame and the kneeling chair at a non-contact distance directly above the non-rigidly supported platform of the dynamic motion therapy device. During treatment, a patient suffering from postural instability or other condition seats on the seat and rests his feet on the non-rigidly supported platform. Accordingly, perturbations or vibrations caused by the non-rigidly supported platform during dynamic treatment of the patient are transferred to the patient while the patient is supported by the kneeling chair support structure.

A patient suffering from a severe case of postural instability or other condition which prevents the patient from standing on the non-rigidly supported platform can be seated on the kneeling chair support structure and be treated with the dynamic motion therapy device. While seated on the seat, the kneeling chair support structure distributes body weight between the seat and the kneeling pads to minimize pressure points. The kneeling chair support structure helps keep the patient's spine in its natural “S” alignment. Additionally, by easing the hips forward, the kneeling chair support structure encourages an upright posture by aligning the back, shoulder and neck, and thereby easing discomfort and pain to the patient.

In another embodiment, the supplemental support structure includes an ergonomic hand support structure having two ergonomic hand supports mounted to a rectangular base via mounting shoes. The rectangular base has a central recess or opening configured and dimensioned for receiving the non-invasive dynamic motion therapy device. During treatment, a patient suffering from postural instability or other condition stands on the non-rigidly supported platform and grasps the two ergonomic hand supports which enable the patient to maintain his balance while being treated by the non-invasive dynamic motion therapy device. Perturbations or vibrations caused by the non-rigidly supported platform during dynamic treatment of the patient are transferred to the patient while the patient is supported by the ergonomic hand support structure. In both embodiments, the mounting shoes are spaced apart in order to enable mounting therein of a standard walker.

In an alternate embodiment, the two ergonomic hand supports are fixed to the rectangular base. In a still alternate embodiment, the rectangular base includes a recess having an electrical connector for connecting to an electrical connector on an underside of the non-invasive dynamic motion therapy device to form an electrical connection. The electrical connection enables the transmission of signals to a display unit of the supplemental support structure such that a display of the display unit displays the same contents as displayed by the display of the non-invasive dynamic motion therapy device.

### BRIEF DESCRIPTION OF THE DRAWINGS

The invention will be described in detail in the following description of preferred embodiments with reference to the following figures wherein:

FIG. 1 is a perspective view showing a non-invasive dynamic motion therapy device in accordance with the present disclosure;

FIG. 2 is a perspective view showing a rectangular base of a kneeling chair support structure receiving the non-invasive dynamic motion therapy device in accordance with the present disclosure;

FIG. 3 is a perspective view showing a kneeling chair of the kneeling chair support structure being mounted to the rectangular base in accordance with the present disclosure;

FIG. 4 is a perspective view showing the kneeling chair of the kneeling chair support structure mounted to the rectangular base in accordance with the present disclosure;

FIG. 5 is a perspective view showing a patient being treated with the non-invasive dynamic motion therapy device while being supported by the kneeling chair support structure;

FIG. 6 is a perspective view showing a walker being mounted to the rectangular base of the kneeling chair support structure;

FIG. 7 is a perspective view showing another embodiment of the rectangular base having mounting shoes with latchable doors for placement of the legs of the walker therein;

FIG. 7A is an enlarged perspective view showing placement of the legs of the walker within the mounting shoes of the rectangular base;

FIG. 8 is a perspective view showing an ergonomic hand support structure in accordance with the present disclosure;

FIG. 9 is a perspective view showing the ergonomic hand support structure receiving the non-invasive dynamic motion therapy device in accordance with the present disclosure;

FIG. 10 is a perspective view showing the ergonomic hand support structure mounted to the non-invasive dynamic motion therapy device;

FIG. 11 is a perspective view showing a patient being treated with the non-invasive dynamic motion therapy device while being supported by the ergonomic hand support structure;

FIG. 12 is a perspective view showing an alternate embodiment of the ergonomic hand support structure in accordance with the present disclosure;

FIG. 13 is a perspective view showing the ergonomic hand support structure shown by FIG. 12 receiving the non-invasive dynamic motion therapy device;

FIG. 14 is a perspective view showing the ergonomic hand support structure shown by FIG. 12 mounted to the non-invasive dynamic motion therapy device;

FIG. 15 is a perspective view showing a patient being treated with the non-invasive dynamic motion therapy device while being supported by the ergonomic hand support structure shown by FIG. 12;

FIG. 16 is a perspective view showing a still alternate embodiment of the ergonomic hand support structure in accordance with the present disclosure;

FIG. 17 is a perspective view showing the ergonomic hand support structure shown by FIG. 16 receiving the non-invasive dynamic motion therapy device;

FIG. 18 is a perspective view showing the ergonomic hand support structure shown by FIG. 16 mounted to the non-invasive dynamic motion therapy device;

FIG. 19 is a perspective view showing a patient being treated with the non-invasive dynamic motion therapy device while being supported by the ergonomic hand support structure shown by FIG. 16;

FIG. 20 is a perspective view showing a still alternate embodiment of the ergonomic hand support structure in accordance with the present disclosure;

FIG. 21 is a perspective view of an ergonomic support structure having an ergonomic hand support structure and a platform for supporting the non-invasive dynamic motion therapy device in accordance with the present disclosure;

FIG. 22 is a perspective view of the ergonomic support structure shown by FIG. 21 with a seat provided thereto for enabling a patient to sit during vibrational treatment by the non-invasive dynamic motion therapy device;

FIG. 23 is a perspective view showing another embodiment of an ergonomic support structure having an ergonomic hand support structure, a monitor and a platform for supporting the non-invasive dynamic motion therapy device in accordance with the present disclosure; and

FIG. 24 is a perspective view showing still another embodiment of an ergonomic support structure having an ergonomic hand support structure, a monitor provided on a column and a platform for supporting the non-invasive dynamic motion therapy device in accordance with the present disclosure.

### DETAILED DESCRIPTION OF PREFERRED EMBODIMENTS

The present disclosure describes several embodiments of supplemental support structures adapted to receive a non-invasive dynamic motion therapy device. The non-invasive dynamic motion therapy device includes a vibration table having a non-rigidly supported platform for providing vibrational treatment to patients suffering from postural instability and other conditions, such as cystic fibrosis, as well as paraplegic patients. The non-invasive dynamic motion therapy device is typically employed following a determination that vibrational treatment of a patient's musculoskeletal system and/or internal organs would produce a beneficial result. The supplemental support structures of the present disclosure enable the patient to be supported on the non-rigidly supported platform of the non-invasive dynamic motion therapy device during treatment as further described below.

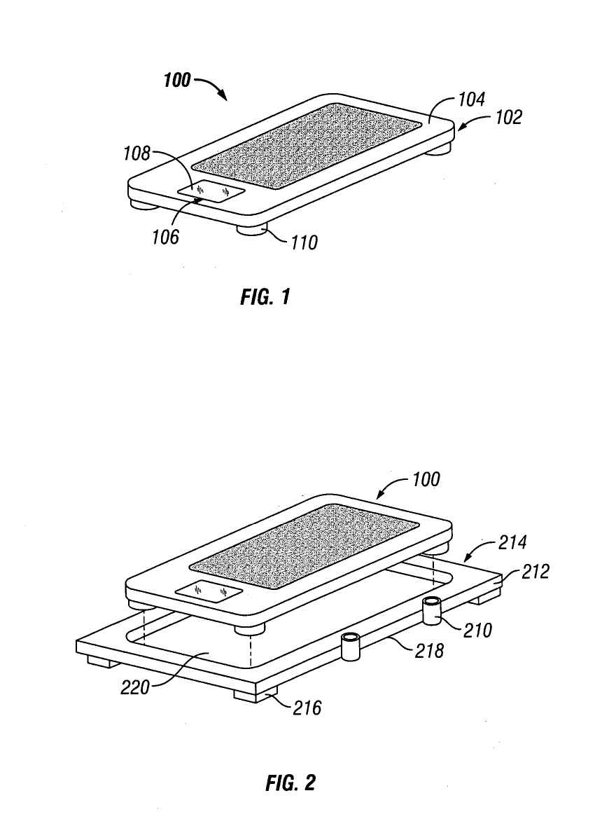

With reference to FIG. 1, there is shown a perspective view of a non-invasive dynamic motion therapy device in accordance with the present disclosure. The non-invasive dynamic motion therapy device is designated generally by reference numeral 100 and includes a vibration table 102 having a non-rigidly supported platform 104. The non-invasive dynamic motion therapy device 100 further includes a display unit 106 having a display 108. The non-invasive dynamic motion therapy device 100 further includes foot rests 110 for resting the device 100 on a flat surface.

The non-rigidly supported platform 104 rests on motorized spring mechanisms (not shown) which cause the platform 104 to move when they are turned on. Alternatively, the non-rigidly supported platform 104 may rest on a plurality of springs or coils which cause the non-rigidly supported platform 104 to move once a patient stands thereon. Further, the non-rigidly supported platform 104 can include various compliant modalities other than springs (e.g., rubber, elastometrics, foams, etc.).

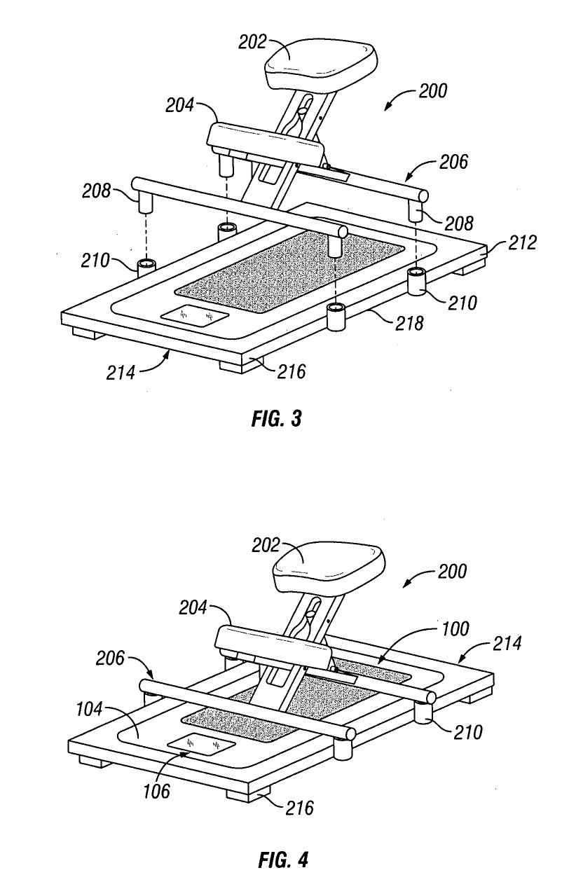

With reference to FIGS. 2 through 6, in a first embodiment of the supplemental support structures in accordance with the present disclosure, a kneeling chair supplemental support structure designated generally by reference numeral 200 is provided having a seat 202 and kneeling pad 204 mounted to a frame 206 (see FIG. 3). The kneeling chair support structure 200 can further include a seat adjustment mechanism for adjusting the height range of the seat 202.

The frame 206 includes four extension members 208 for mating with four mounting shoes 210 provided on an outboard side 212 of a rectangular base 214. The rectangular base 214 includes four support members 216 on an underside 218 thereof. As shown by FIG. 2, the rectangular base 214 further includes an opening 220 configured and dimensioned for receiving therein the non-invasive dynamic motion therapy device 100.

After the non-invasive dynamic motion therapy device 100 is received within the opening 220 of the rectangular base 214 and the extension members 208 of the frame 206 are mated with the mounting shoes 210, the seat 202 of the kneeling chair support structure 200 lies above the non-rigidly supported platform 104, as shown by FIG. 4. Additionally, as shown by FIG. 4, the frame 206 does not rest on the non-rigidly supported platform 104, since the mounting shoes 210 extend above the planar surface of the non-rigidly supported platform 104, thereby preventing any portion of the frame 206 from resting on the non-rigidly supported platform 104.

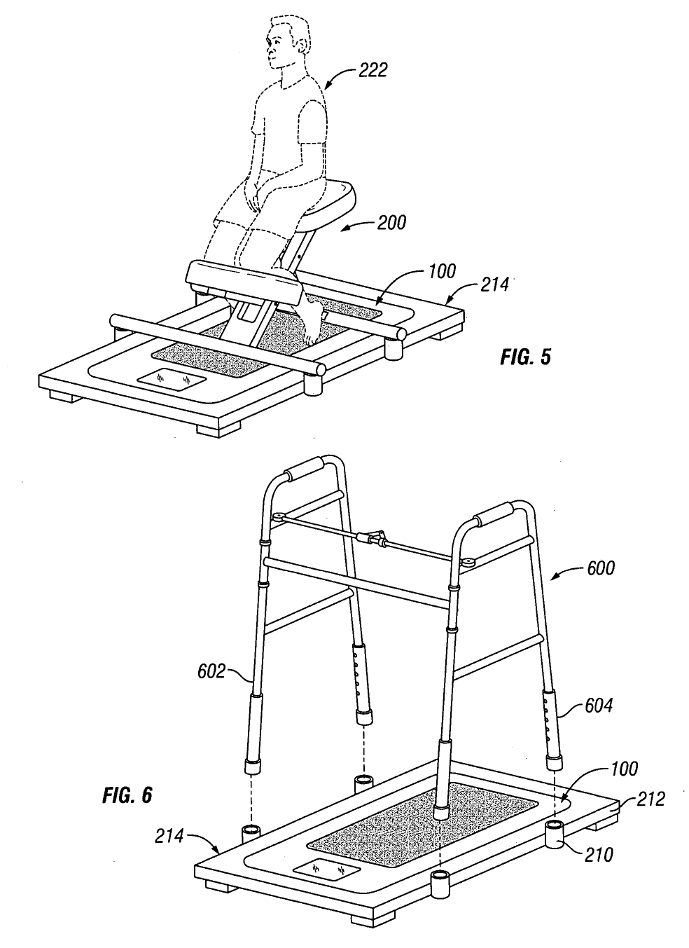

With reference to FIG. 5, during operation of the non-invasive dynamic motion therapy device 100 for treating a patient 222 suffering from postural instability or other condition, perturbations or vibrations caused by the non-rigidly supported platform 104 are transferred to a patient 222 via the patient's feet which rest on the non-rigidly supported platform 104.

A patient suffering from a severe case of postural instability or other condition which prevents the patient from standing on the non-rigidly supported platform 104 can be seated on the seat 202 of the kneeling chair support structure 200 and be treated with the dynamic motion therapy device 100. While seated on the seat 202, as shown by FIG. 5, the kneeling chair support structure 200 distributes body weight between the seat 202 and the kneeling pad 204 to minimize pressure points. The kneeling chair support structure 200 helps keep the patient's spine in its natural “S” alignment. Additionally, by easing the hips forward, the kneeling chair support structure 200 encourages an upright posture by aligning the back, shoulder and neck, and thereby easing discomfort and pain to the patient.

With reference to FIG. 6, it is provided that the mounting shoes 210 further enable the mounting of the lower portions of the front and rear legs 602, 604 of a walker 600 to the rectangular base 214 of kneeling chair support structure 200. It is contemplated that the mounting shoes 210 can be moveable along the outboard side 212 of the vibration table 102 to accommodate walkers having varying distance between the front and rear legs 602, 604. In the embodiment shown by FIG. 6, the walker 600 acts in great part as the supplemental support structure.

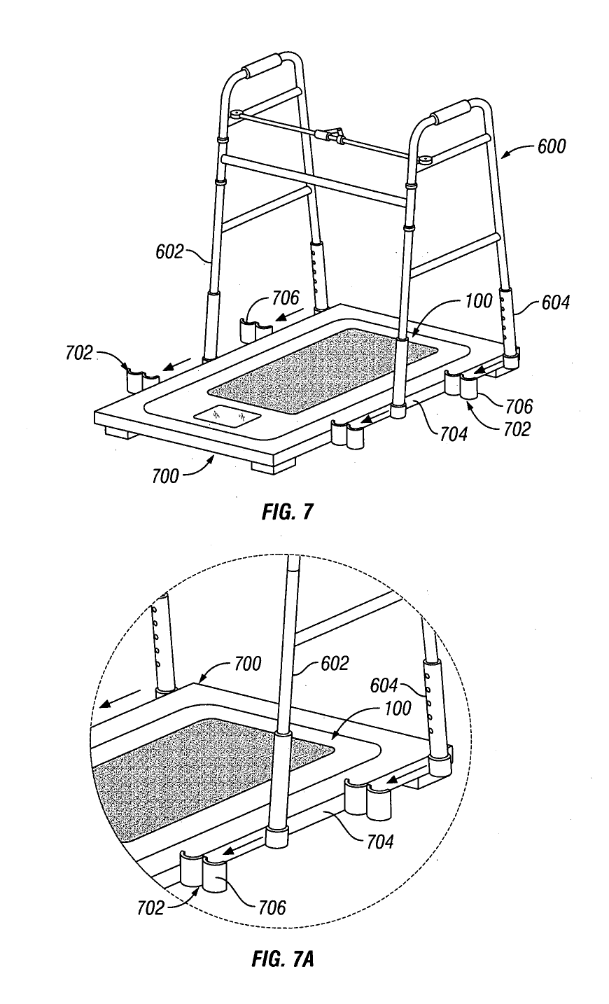

In an alternate embodiment of the rectangular base 214 of the kneeling chair support structure 200 as shown by FIGS. 7 and 7A and designated generally by reference numeral 700, clam-type mounting shoes 702 are provided to an outboard side 704 of the rectangular base 700 each including a latchable door 706 which opens and closes for laterally inserting and securing the lower portions of the front and rear legs 602, 604 of the walker 600 to the mounting shoes 702 without having to lift the walker 600.

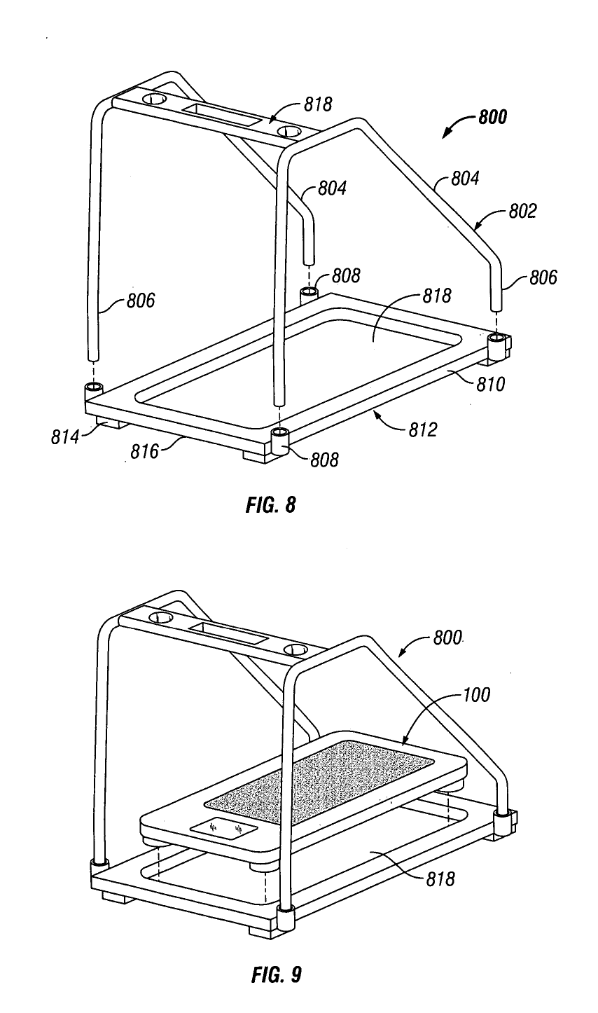

In a second embodiment of the supplemental support structure, an ergonomic hand support structure is provided as shown by FIG. 8 and designated generally by reference numeral 800. The ergonomic hand support structure 800 includes a frame 802 having two ergonomic hand supports 804. The frame 802 includes four extension members 806 for mating with four mounting shoes 808 provided on an outboard side 810 of a rectangular base 812. The mounting shoes 808 can be spaced apart in order for a walker to be mounted to the rectangular base 812 as described above with respect to the kneeling chair support structure 200. The rectangular base 812 further includes four support members 814 on an underside 816 thereof.

At one end, the hand supports 804 are adjoined by a lateral member 818. The lateral member 818 can include one or more of the following: a work area for enabling the patient to place a laptop or other computing device, a book, a writing pad, a radio, a television, etc.; an electrical outlet for plugging an electrical cord of an electrical device; a cup and/or bottle holder; a display for displaying treatment and other information, such as remaining treatment time and frequency of vibration of the vibration table 102; a control panel for controlling the operation the dynamic motion therapy device 100; interface circuitry for connecting medical equipment to the dynamic motion therapy device 100, such as electrodes, heart monitor, blood pressure monitor, etc.; and an entertainment console for playing video games, CDs, etc.

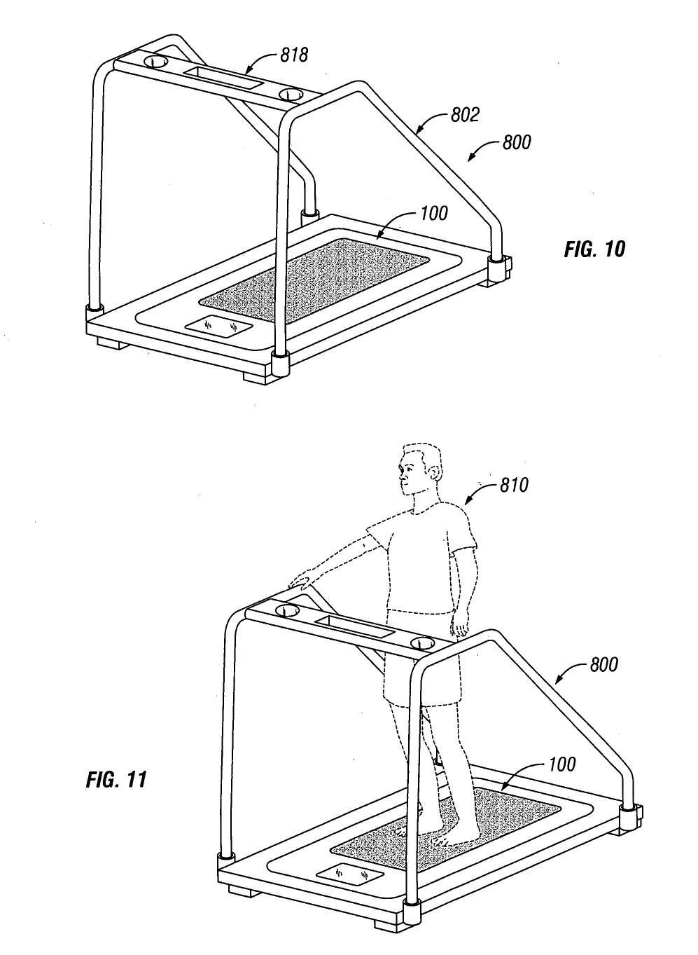

As shown by FIGS. 8-10, the rectangular base 812 further includes an opening 818 configured and dimensioned for receiving therein the non-invasive dynamic motion therapy device 100. After the non-invasive dynamic motion therapy device 100 is received within the opening 818 of the rectangular base 812 and the extension members 806 of the frame 802 are mated with the mounting shoes 808, a patient 810 suffering from postural instability or other condition can stand on the non-rigidly supported platform 104 and be vibrated by perturbations or vibrations caused by the non-rigidly supported platform 104. During treatment, the two ergonomic hand supports 804 enable the patient 810 to grasp and maintain his balance while being treated by the non-invasive dynamic motion therapy device 100.

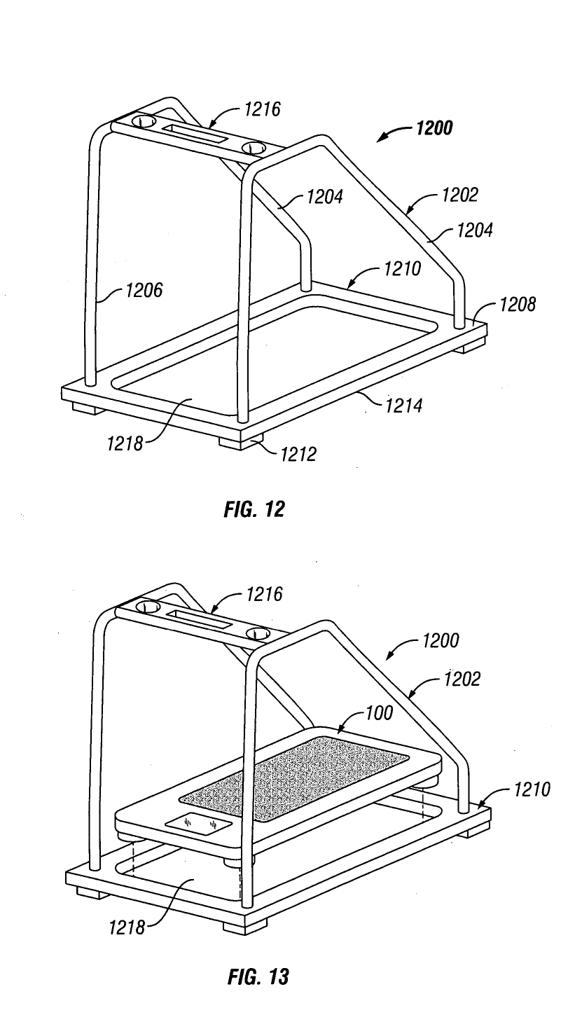

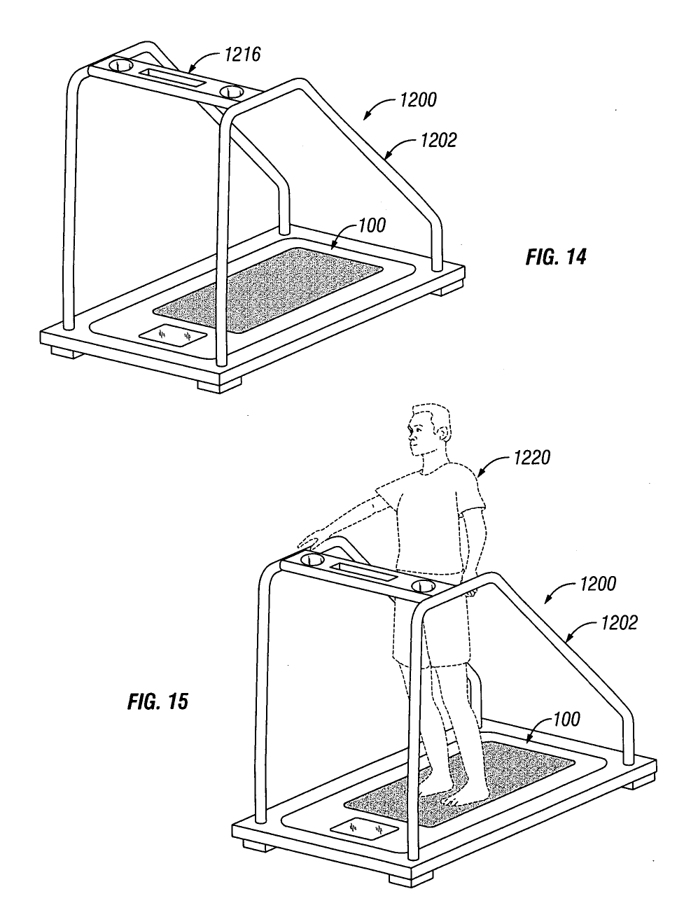

FIGS. 12-15 show an alternate embodiment of the ergonomic hand support structure. The alternate embodiment of the ergonomic hand support structure is designated generally by reference numeral 1200 and it includes similar parts as the ergonomic hand support structure 800 other than the mounting shoes. In this embodiment, the ergonomic hand support structure 1200 includes a frame 1202 having two ergonomic hand supports 1204. The frame 1202 further includes four tubular extension members 1206 fixedly mounted to a planar top surface 1208 of a rectangular base 1210. The rectangular base 1210 includes four support members 1212 on an underside 1214 thereof.

At one end, the hand supports 1204 are adjoined by a lateral member 1216. The lateral member 1216 can include one or more of the following: a work area for enabling the patient to place a laptop or other computing device, a book, a writing pad, a radio, a television, etc.; an electrical outlet for plugging an electrical cord of an electrical device; a cup and/or bottle holder; a display for displaying treatment and other information, such as remaining treatment time and frequency of vibration of the vibration table 102; a control panel for controlling the operation the dynamic motion therapy device 100; interface circuitry for connecting medical equipment to the dynamic motion therapy device 100, such as electrodes, heart monitor, blood pressure monitor, etc.; and an entertainment console for playing video games, CDs, etc.

The rectangular base 1210 further includes an opening 1218 configured and dimensioned for receiving therein the non-invasive dynamic motion therapy device 100. After the non-invasive dynamic motion therapy device 100 is received within the opening 1218 of the rectangular base 1210, a patient 1220 suffering from postural instability or other condition can stand on the non-rigidly supported platform 104 and be vibrated by perturbations or vibrations caused by the non-rigidly supported platform 104. During treatment, the two ergonomic hand supports 1204 enable the patient 1220 to grasp and maintain his balance while being treated by the non-invasive dynamic motion therapy device 100.

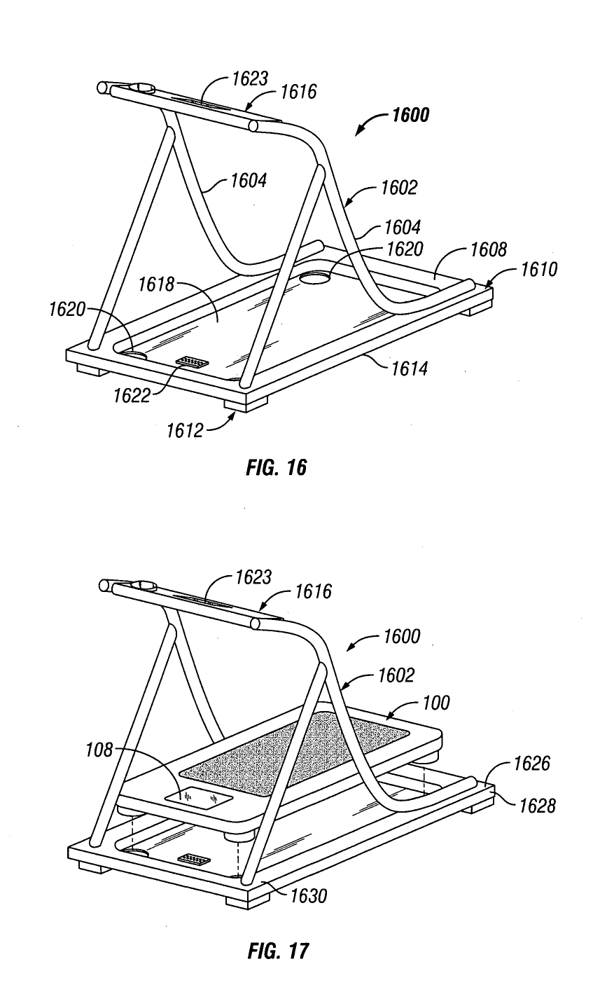

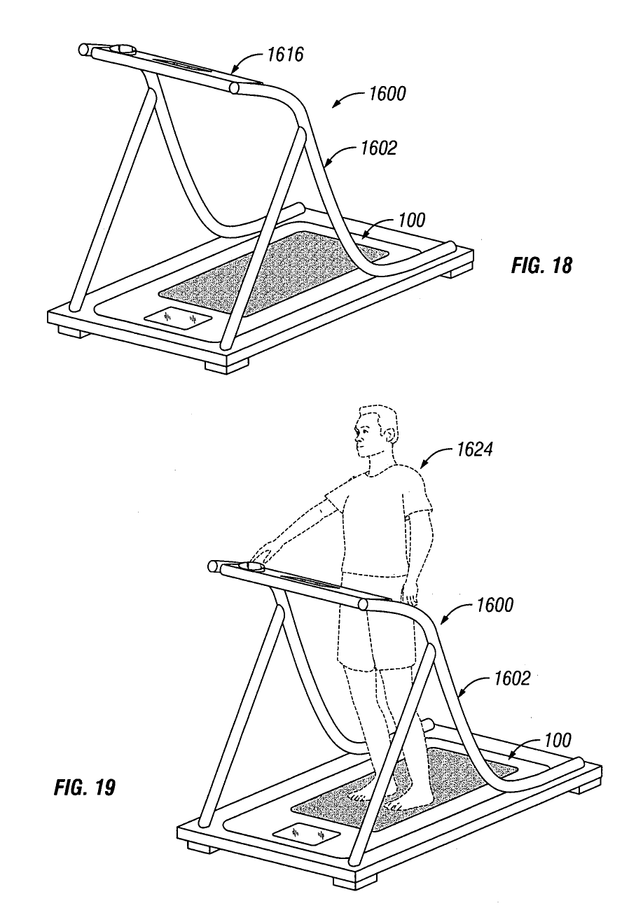

With reference to FIGS. 16-19, there is shown another embodiment of a supplemental support structure in accordance with the present disclosure and designated generally by reference numeral 1600. In this embodiment, the ergonomic hand support structure 1600 includes a frame 1602 having two ergonomic hand supports 1604. The frame 1602 is mounted to a planar top surface 1608 of a rectangular base 1610. The rectangular base 1610 includes four support members 1612 on an underside 1614 thereof.

At one end, the hand supports 1604 are adjoined by a lateral member 1616. The lateral member 1616 can include one or more of the following: a work area for enabling the patient to place a laptop or other computing device, a book, a writing pad, a radio, a television, etc.; an electrical outlet for plugging an electrical cord of an electrical device; a cup and/or bottle holder; a display for displaying treatment and other information, such as remaining treatment time and frequency of vibration of the vibration table 102; a control panel for controlling the operation the dynamic motion therapy device 100; interface circuitry for connecting medical equipment to the dynamic motion therapy device 100, such as electrodes, heart monitor, blood pressure monitor, etc.; and an entertainment console for playing video games, CDs, etc.

The rectangular base 1610 further includes a recessed center 1618 configured and dimensioned for receiving therein the non-invasive dynamic motion therapy device 100. The four corners of the recessed center 1618 have openings 1620 in order for each foot rest 110 of the device 100 to pass through. The recessed center 1618 includes an electrical connector 1622 at one end thereof for electrically connecting with an electrical connector (not shown) on an underside of the non-invasive dynamic motion therapy device 100. Once the two electrical connectors are connected with each other, a display 1623 on the lateral member 1616 displays the same content as the display 108 of the non-invasive dynamic motion therapy device 100.

After the non-invasive dynamic motion therapy device 100 is received within the opening 1620 of the rectangular base 1610 and the two electrical connectors are connected with each other, a patient 1624 suffering from postural instability or other condition can stand on the non-rigidly supported platform 104 and be vibrated by perturbations or vibrations caused by the non-rigidly supported platform 104. During treatment, the two ergonomic hand supports 1604 enable the patient 1624 to grasp and maintain his balance while being treated by the non-invasive dynamic motion therapy device 100.

As shown by FIGS. 16-19, the ergonomic hand supports 1604 steadily rise from one end 1626 of the rectangular base 1610 along the periphery outer edges 1628 of the rectangular base 1610 to an opposing end 1630 along the periphery outer edges 1628 of the rectangular base 1610. This robust design of the ergonomic hand support structure 1600 enables patients having different heights to be able to grasp the hand supports 1604 and be treated by the non-invasive dynamic motion therapy device 100.

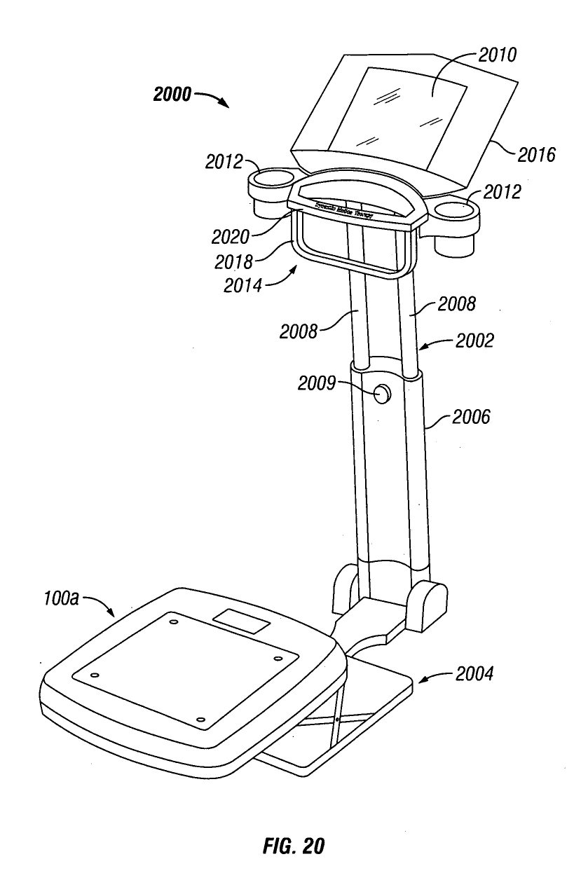

With reference to FIG. 20 there is shown a perspective view of an alternate embodiment of the ergonomic hand support structure in accordance with the present disclosure. The alternate embodiment of the ergonomic hand support structure is designated generally by reference numeral 2000. In this embodiment, the ergonomic hand support structure 2000 includes a frame 2002 having a mounting tray 2004 for placement of a non-invasive dynamic motion therapy device 100a thereon as shown by FIG. 20. The mounting tray 2004 is pivotable with respect to a vertical column 2006 of the frame 2002 at one end of the vertical column 2006 configured for standing the frame 2002 on a flat surface. Another end of the vertical column 2006 includes two parallel extension bars 2008 protruding vertically from the vertical column 2006.

The two parallel extension bars 2008 support a monitor 2010, two cup holders 2012 and a hand support structure 2014. The two parallel extension bars 2008 slide in and out of the vertical column 2006 for changing the height of the frame 2002 by pulling on adjustment knob 2009.

The monitor 2010 displays treatment information and other information, including video, to a patient during vibrational treatment. The monitor 2010 is provided within a monitor support 2016. Preferably, the monitor 2010 is inlaid within the monitor support 2016 for enabling a patient to place a book, laptop, etc. on the monitor support 2016 without contacting the monitor 2016.

The hand support structure 2014 includes a curved holding bar 2018 and a lateral holding bar 2020. It is desirable for the patient to grasp the lateral holding bar 2020 when stepping on and off the non-invasive dynamic motion therapy device 100a and to grasp the curved holding bar 2018 during vibrational treatment.

After the non-invasive dynamic motion therapy device 100a is placed on the mounting tray 2004, a patient suffering from postural instability or other condition can stand on the non-rigidly supported platform 104 and be vibrated by perturbations or vibrations caused by the non-rigidly supported platform 104. During treatment, the curved holding bar 2018 enables the patient to grasp and maintain his balance while being treated by the non-invasive dynamic motion therapy device 100a.

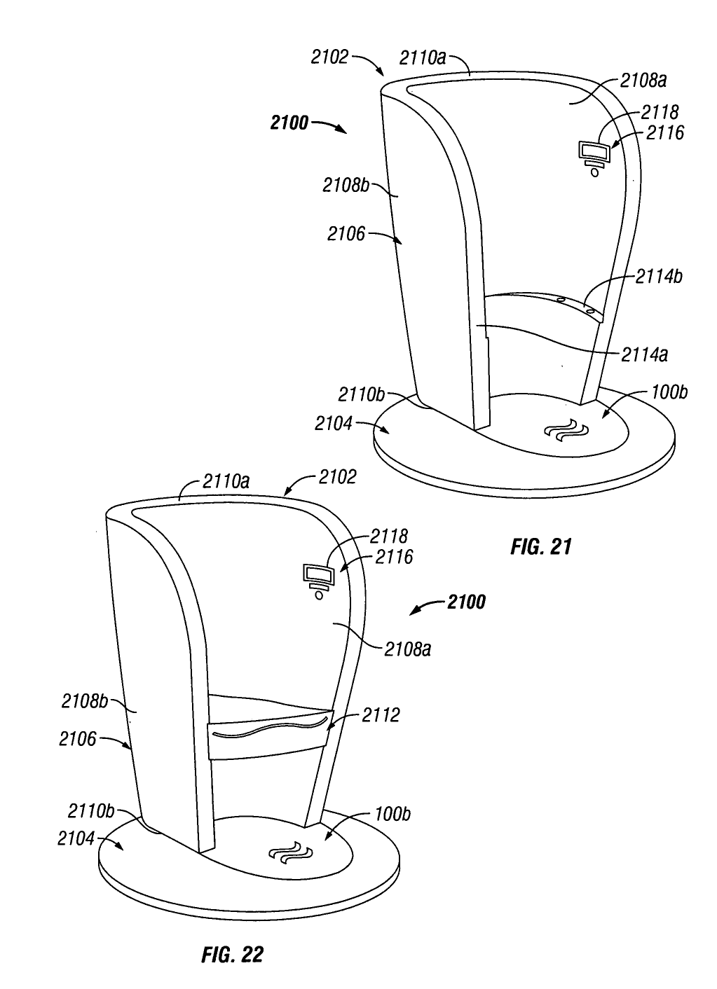

FIGS. 21 and 22 show perspective views of an ergonomic support structure designated generally by reference numeral 2100. The ergonomic support structure 2100 includes an ergonomic hand support structure 2102 and a platform 2104 for supporting a non-invasive dynamic motion therapy device 100b. The non-invasive dynamic motion therapy device 100b is preferably removable from the platform 2104 as described above for other embodiments in accordance with the present disclosure.

The ergonomic hand support structure 2102 includes a curved structure 2106 having inner and outer curved walls 2108a, 2108b and two curved ends 2110a, 2110b connecting the two walls 2108a, 2108b. During vibrational treatment by the non-invasive dynamic motion therapy device 100a, the patient grasps the long curved end 2110a or lightly touches the inner curved wall 2108a.

The ergonomic support structure 2100 further includes a seat 2112 (FIG. 22) for placement on two opposing surfaces 2114a, 2114b defined by the inner curved wall 2108a. Accordingly, during vibrational treatment by the non-invasive dynamic motion therapy device 100a, the patient can sit on the seat 2112.

The ergonomic support structure 2100 further includes an RFID reader 2116 for reading an RFID tag provided on the patient for identifying the patient. The RFID reader 2116 further includes a display 2118 for displaying patient identification data and other data, including video. The RFID reader 2116 also includes a processor (not shown) storing patient-related data, such as patient identification data, and treatment data, such as, for example, the dates and duration times of the last five vibrational treatment sessions. The patient-related data for each particular patient is accessed and portions thereof displayed by the display 2118 after the patient's corresponding RFID tag is read by the RFID reader 2116.

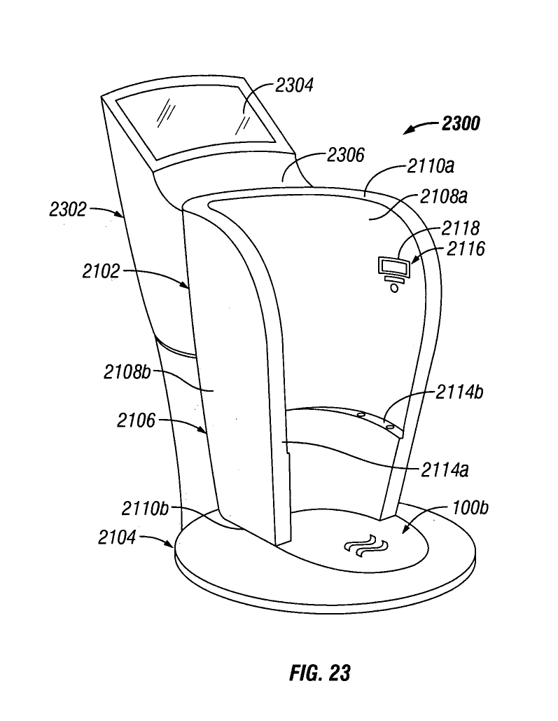

FIG. 23 shows a perspective view of another embodiment of an ergonomic support structure designated generally by reference numeral 2300. The ergonomic support structure 2300 is similar in structure and operation to the ergonomic support structure 2100 as identified by identical reference numerals. The ergonomic support structure 2300 can also be provided with a seat 2112 as similarly described above for the ergonomic support structure 2100.

The ergonomic support structure 2300 includes a vertical column 2302 butting against a portion of the outer curved wall 2108b as shown by FIG. 23. The vertical column 2302 includes a monitor 2304 for displaying patient identification data and other data, such as patient treatment data, including video. Preferably, the monitor 2304 is inlaid within the vertical column 2302 for enabling the patient to place a book, laptop, etc. on the vertical column 2302 without contacting the monitor 2304. The monitor 2304 is preferably touch-sensitive for controlling the operation of the non-invasive dynamic motion therapy device 100a and performing other functions, such as accessing the Internet, accessing data stored within a memory, etc., by touching the screen of the monitor 2304. The vertical column 2302 further includes a recessed area 2306 below the top portion of the curved end 2110a for enabling the patient to grasp the curved end 2110a at this location.

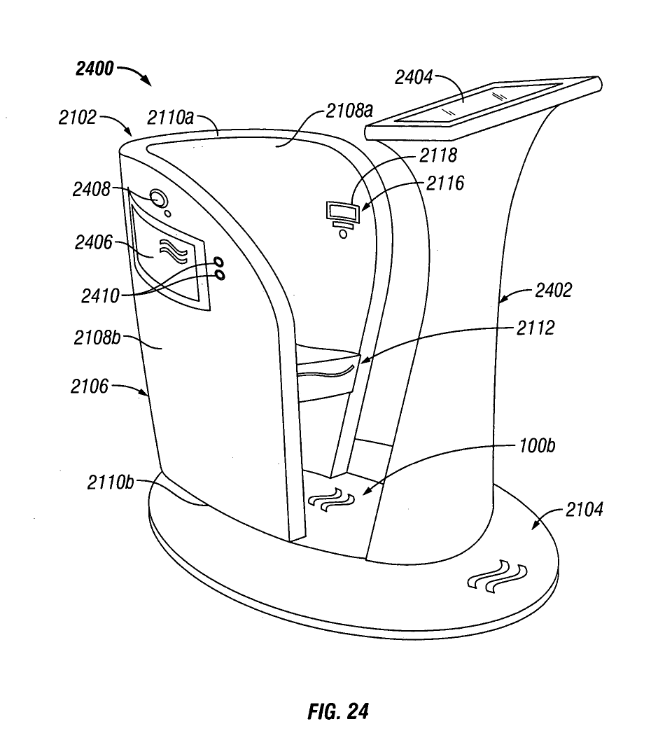

FIG. 24 shows a perspective view of another embodiment of an ergonomic support structure designated generally by reference numeral 2400. The ergonomic support structure 2400 is similar in structure and operation to the ergonomic support structures 2100 and 2300 as identified by identical reference numerals. The ergonomic support structure 2400 is provided with a removable seat 2112 as similarly described above for the ergonomic support structure 2100.

The ergonomic support structure 2400 includes a vertical column 2402 having a monitor 2404 for displaying patient identification data and other data, such as patient treatment data, including video. Preferably, the monitor 2404 is inlaid within the vertical column 2402 for enabling the patient to place a book, laptop, etc. on the vertical column 2402 without contacting the monitor 2404. The vertical column 2402 is preferably height adjustable to accommodate patients of differing heights. Another monitor 2406 is provided on the outer wall 2108b. The outer wall 12108b is further provided with a light source 2408 above the monitor 2406 and control buttons 2410.

It is contemplated to provide the support structures shown by FIGS. 20-24 with circuitry and related components for connecting to a network, such as the Internet, wirelessly and/or non-wirelessly and at least one processor for transmitting and receiving data via the network as known in the art. The data transmitted can include patient monitoring data to determine at a central monitoring station if the patient is complying with a treatment regiment and data to determine whether the patient is properly positioned on the dynamic motion therapy device to obtain optimum treatment effects. The data can include video and/or sensor data obtained by a video camera and/or at least one sensor mounted to the support structures and transmitted via the network to the central monitoring station. The data received can include Internet content and treatment-related data transmitted from the central monitoring station. The data received can include visual and/or audio content for viewing via the monitor 2010, 2304, 2404 and/or listening via earphones connected to audio circuitry embedded within the support structures.

The non-invasive dynamic motion therapy devices 100, 100a, 100b illustrated by the various figures and described herein operate in a similar manner to provide dynamic motion therapy to patients supported thereon by the supplemental support structures described herein.

Other types of supplemental support structures are envisioned for receiving the non-invasive dynamic motion therapy devices 100, 100a, 100b, such as supplemental support structures having different types of seating and grasping arrangements and designs. For example, the kneeling chair in the first embodiment of the supplemental support structure disclosed herein can be replaced by another type of chair.

It is therefore understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

What is claimed is:

1. A support structure device comprising:
means for engaging a dynamic motion therapy device of the type having a non-rigidly supported platform capable of providing vibrational treatment to a patient in contact with the non-rigidly supported platform; and
support means operatively connected to the means for engaging for supporting the patient in contact with the non-rigidly supported platform.

2. The device as recited in claim 1, wherein the support means includes a chair comprising a seat mounted to a frame for enabling the patient to seat during the vibrational treatment.

3. The device as recited in claim 2, wherein the means for engaging includes a base, and wherein the frame is operatively connected to the base.

4. The device as recited in claim 2, wherein the chair is a kneeling chair.

5. The device as recited in claim 1, wherein the support means includes two hand supports mounted to a frame.

6. The device as recited in claim 5, wherein the means for engaging includes a base, and wherein the frame is operatively connected to the base.

7. The device as recited in claim 5, wherein the hand supports are operatively connected by a lateral member, wherein the lateral member includes one or more of the following: a work area; an electrical outlet; a cup and/or bottle holder; a display for displaying treatment and other information; a control panel for controlling the operation of the device; interface circuitry for connecting equipment to the device; and an entertainment console for enabling play of video games and CDs.

8. The device as recited in claim 1, wherein the means for supporting comprises a frame having extension members each configured and dimensioned to mate with a respective mounting shoe extending from a base of the means for engaging for operatively connecting the frame to the base.

9. The device as recited in claim 8, wherein at least one mounting shoe includes a door which opens and closes for laterally inserting at least one extension member therein.

10. The device as recited in claim 1, wherein the means for engaging includes an electrical connector for electrically connecting with an electrical connector of the dynamic motion therapy device.

11. A support structure device comprising:
a base defining an opening configured and dimensioned for receiving therein a dynamic motion therapy device of the type having a non-rigidly supported platform capable of providing vibrational treatment to a patient in contact with the non-rigidly supported platform; and
a support mechanism operatively connected to the base and having at least one support member for supporting the patient in contact with the non-rigidly supported platform.

12. The device as recited in claim 11, wherein the at least one support member is a chair comprising a seat mounted to a frame for enabling the patient to seat during the vibrational treatment.

13. The device as recited in claim 12, wherein the chair is a kneeling chair.

14. The device as recited in claim 11, wherein the support mechanism includes a frame operatively connected to the base.

15. The device as recited in claim 11, wherein the at least one support member is a hand support mounted to a frame.

17. The device as recited in claim 11, wherein the at least one support includes a first hand support and a second hand support, said first and second hand supports are operatively connected by a lateral member, wherein the lateral member includes one or more of the following: a work area; an electrical outlet; a cup and/or bottle holder; a display for displaying treatment and other information; a control panel for controlling the operation of the device; interface circuitry for connecting equipment to the device; and an entertainment console for enabling play of video games and CDs.

18. The device as recited in claim 11, wherein the support mechanism comprises a frame having extension members each configured and dimensioned to mate with a respective mounting shoe extending from the base for operatively connecting the frame to the base.

19. The device as recited in claim 18, wherein at least one mounting shoe includes a door which opens and closes for laterally inserting at least one extension member therein.

20. The device as recited in claim 11, wherein the base includes an electrical connector for electrically connecting with an electrical connector of the dynamic motion therapy device.

21. A kneeling chair support structure device comprising:
a base defining an opening configured and dimensioned for receiving therein a dynamic motion therapy device of the type having a non-rigidly supported platform capable of providing vibrational treatment to a patient in contact with the non-rigidly supported platform; and
a kneeling chair support mechanism operatively connected to the base and having a seat and at least one kneeling pad for supporting the patient in contact with the non-rigidly supported platform.

22. A hand support structure device comprising:
a base defining an recess configured and dimensioned for receiving therein a dynamic motion therapy device of the type having a non-rigidly supported platform capable of providing vibrational treatment to a patient in contact with the non-rigidly supported platform; and
at least one hand support operatively connected to the base for supporting the patient in contact with the non-rigidly supported platform.
